(19) United States
(12) Patent Application Publication
(10) Pub. No.: US 2022/0291528 A1
(43) Pub. Date: Sep. 15, 2022

(54) PORTABLE EYE-GLASSES CLEANING DEVICE

(71) Applicant: Juan C. Rincón, Bogotá (CO)

(72) Inventor: Juan C. Rincón, Bogotá (CO)

(21) Appl. No.: 17/636,348

(22) PCT Filed: Aug. 18, 2020
(86) PCT No.: PCT/US2020/046870

§ 371 Date: Feb. 17, 2022

Related U.S. Application Data
(60) Provisional application No. 62/888,733, filed on Aug. 19, 2019.

(51) Int. Cl. G02C 13/00; B08B 1/00; B08B 11/02

(52) U.S. Cl. CPC G02C 13/006; B08B 1/006; B08B 1/008; B08B 1/002; B08B 11/02

(57) ABSTRACT

A method of cleaning portable eye-glasses and a electromechanical portable eye-glasses cleaning device using microfiber cleaning pads to simultaneously come into contact with both sides of the lens, providing a uniform, soft and effective cleaning by the rotation friction of microfiber pads; without leaving lines or spots in their path and without causing damage to the lens.

### BACKGROUND

Eye-glasses users face endless difficulties to keep their glasses completely clean. Eye-glasses remain dirty because air contamination and dust easily adhere to one or more lenses of the eye-glasses. Furthermore, finger contact with lenses, as well as a user's body heat, humidity and sweating results in eyeglasses becoming foggy and dirty, which often results in discomfort for users.

Although there are a variety of eyeglasses cleaning devices in the market, none of them is based on a mixture of an electronic-mechanical apparatus that delivers a portable and effective solution for the endless problem of dirty eye-glasses.

This novel cleaning system removes dirt and dust, polishing lens in three simple steps without direct hand contact. In one hand, some effective inventions for cleaning eye-glasses are big, non-portable, impractical, time consuming and difficult to be used; on the other hand, portable, small, lightweight eye-glasses cleaners currently available in the market, have just simple manual features that are not completely effective.

Accordingly, it is desired to provided systems and methods that solve the disadvantages in the prior art.

### BRIEF SUMMARY OF THE INVENTION

It is an object of the present invention to provide a method and system for a portable eye-glasses cleaner.

It is an object of the device to be small and lightweight.

It is an object of the device to fit on the palm of a hand of a user.

It is an object of the device to be easily used, carried on and stored, giving peace of mind to users.

Objects of the invention are achieved by providing a portable eye-glasses cleaning device that is configured to allow users to wipe the lens by using an easy, fast and effective semi-automated procedure. The device is specially designed to effectively reach and clean both surfaces of the lens glasses no matter the shape of them.

In certain embodiments, the portable eye-glasses cleaning device is an electromechanical portable eye-glasses cleaning device.

In certain embodiments, a feasible three-step guide to using the device can describe how this invention works:
(1) remove excess of dust from both eye-glasses lens faces with the retractile cleaning brush.
(2) using the refillable spray mini bottle for eye-glasses cleaner solution, put some eye-glasses cleaning solution on both sides of lens;
(3) one at a time, place the lens of glasses between the upper and lower substitutable cleaning pads and press down the left and right assembled covers; allowing them to move vertically down to provide an electronic or mechanical feeding of rotational motion to holder plates by means of impulse mechanism or by the micromotors feed by a battery and the wires; activated by an inner limit switch, giving the holder plates the required rotational motion.

In certain embodiments, pressure on the left and right assembled covers will cause the assembled junction cover of the mechanism to move vertically downwards, making both upper and lower microfiber cleaning pads to simultaneously come into contact with both sides of the lens, which will provide an uniform, soft and effective cleaning by the rotation friction of microfiber pads; without leaving lines or spots in their path and without causing damage to lens.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

For better understanding and avoiding overcrowded and confusing figures, wires, connectors, screws, pins and other small parts are not shown in figures, additionally not all components are shown within all the following three figures:

FIG. 1. Shows left side view of an embodiment of the device;

FIG. 2. Illustrates front or elevation view of an embodiment of the device;

FIG. 3. Presents top view or floor of an embodiment of the device.

### DETAILED DESCRIPTION AND BEST MODE OF IMPLEMENTATION

In the following description, numerous details are set forth for the purpose of explanation. However, one of ordinary skill in the art will realize that the invention may be practiced without the use of these specific details.

According to embodiments of the invention, all components are set in one single device that could be made of several kind of materials, such as any kind of plastic and/or metallic elements, as well as electronic and mechanical components, which can be configured in different positions and arrangements into the device.

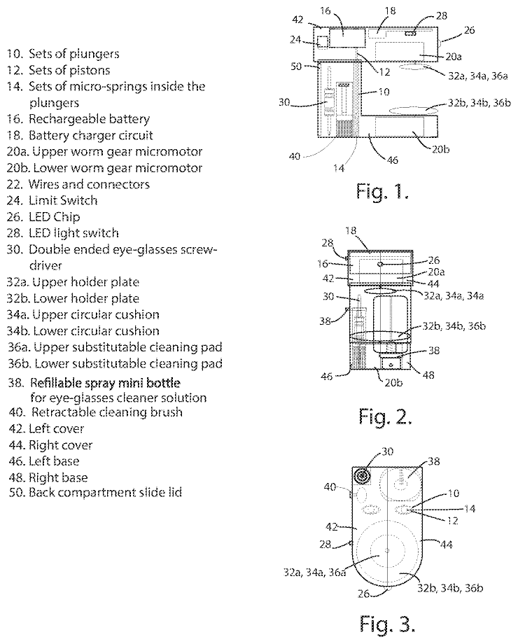

The invention is composed but not limited for the following elements: the device includes a well-designed mechanism to move the left and right (42 and 44) covers on a vertical axis over the left and right (46 and 48) bases and provide rotational motion to the upper and lower holder plates (32a and 32b). These elements are shown in FIGS. 1-3, which is an exemplary embodiment of the invention.

With the aim of providing a softer cleaning a upper circular cushion (34a) will be added and glued on the bottom of upper holder plate (32a), as well as on the top of lower holder plate (34b); thus, two (2) circular cushions will be set between holders plates (32a and 32b) and substitutable cleaning pad (36a and 36b). These cushions will provide an additional protection lay between holder plates and lens, minimizing lens damage possibilities.

Following a rectilinear motion over Y axis, assembled junction covers (42 and 44), move vertically up and down over the lower assembled (46 and 48) bases; throughout a number of sets of pistons (12), plungers (10) and micro-springs (14) or other compression mechanism.

Inside the plungers (10) and between left and right assembled bases (44 and 46) and the set of pistons (12) are the micro-springs (14), which once squeezed create a load to move up the left and right (42 and 44) assembled covers. In certain embodiments, the device could have 1, 2, 3 or more sets of plungers, pistons and micro-springs and alternatively can use a different moving compression mechanism.

As shown in certain embodiments, the upper holder plate (32a) and the upper circular cushion (34a), covered with the upper substitutable cleaning pad (36a) is gathered to the axis of the upper worm gear motor (20a), which is assembled with its pivot down between the left and right covers (42 and 44). As shown in certain embodiments, just below the same vertical Y axis of upper micromotor (20a) between the left and right bases (46 and 48), is put together with its pivot up; the lower micromotor (20b), on which axis is assembled the lower holder plate (32b) covered with the lower circular cushion (34b) and the lower substitutable cleaning pad (36b). Substitutable cleaning pads of the device can be manufactured using microfiber cloth, or other eye-glasses cleaning fabric or material.

If rotational motion is provided by worm gear micromotors (20a and 20b), they will be fed by a battery (16) which could be either regular or rechargeable, last one with the help of a battery charger circuit (18). The Device could be turn on by a limit switch (24) that could be located at the rear bottom of assembled left and right covers (42 and 44).

A LED chip (26) could be located in front side of the device covers and is turned on by a circuit incorporated LED switch (28), which is located at the left side of the right cover. Battery charger circuit (18) is placed at the top, but under the device assembled covers (42 and 44).

In certain embodiments, some of these components are set together by wires and connectors (22) to deliver the required energy from the rechargeable battery (16). The portable electronic-mechanical eye-glasses cleaning device could be manufactured using worm gear micromotors or other substitution manual impulse mechanism, electric, electronic or magnetic components, which also provide rotational motion to the upper and lower holder plates (32a and 32b).

In certain embodiments, a Retractable cleaning brush (40) could be assembled into the left base (46) and could be manually operated by a moving button on the side of the device. On the back of the left and right bases (46 and 48) junction is a double volume compartment box, which contains the refillable spray mini bottle for eye-glasses cleaner solution (38), and the double ended eye-glasses screwdriver (30). The double volume compartment box is closed by the back-compartment slide lid (50).

In certain embodiments, the device may be assembled according to different methods, one of them will be the following:
(1) Assemble left junction composed by the left base and cover. Left base could incorporate a set of plungers, likewise left cover could incorporate a set of pistons, thus prior to assemble left base and cover, insert one micro spring into each one of plungers, then take care that pistons get into its corresponding plungers and get locked.
(2) Using corresponding wires and connectors, connect charging circuit with the following inner components: a) the battery, b) the LED chip, and c) the limit switch; then connect the limit switch the upper and lower worm gear motors.
(3) Set all prior wire connected components; charger circuit, rechargeable battery, limit switch, upper worm gear motor, and lower worm gear motor into the assembled left base and cover. Upper worm gear micromotors axes may be on the same vertical line of the lower micromotor axes.
(4) Assemble right junction composed by the right base and right cover. Right base could incorporate a set of plungers, likewise right cover could incorporate a set of pistons; thus, prior to assemble right base and cover, insert one micro spring into each one of plungers, then take care that pistons get into its corresponding plungers and get locked.
(5) Then get together the previously assembled left junction over which inner components have been already installed, with the previously assembled right junction, securing both left and right junctions with corresponding pins and screws.
(6) Set the lower holder plate on the lower worm gear micromotor axes and also set the upper holder plate on the upper worm gear micromotor axes.
(7) Put on the upper and lower circular cushions on the corresponding holder plates.
(8) Put on the upper and lower substitutable pads on the corresponding circular cushions and holder plates.
(9) Then install retractile cleaning brush.
(10) Set up and secure the accessories such as double ended eye-glasses screwdriver, and the refillable spray mini bottle for eye-glasses cleaner solution into the backside boxes of the base junction, which finally will be closed with the back-compartment slide lid.

Having thus described several embodiments for practicing the inventive method, its advantages and objectives can be easily understood. Variations from the description above may and can be made by one skilled in the art without departing from the scope of the invention.

Accordingly, this invention is not to be limited by the embodiments as described, which are given by way of example only and not by way of limitation.

### LIST OF COMPONENTS

10. Sets of plungers

12. Sets of pistons

14. Sets of micro-springs inside the plungers

16. Rechargeable battery

18. Battery charger circuit

20a. Upper worm gear micromotor

20b. Lower worm gear micromotor

22. Wires and connectors

24. Limit Switch

26. LED Chip

28. LED Switch (incorporated into the battery charger circuit)

30. Double ended eye-glasses screwdriver

32a. Upper holder plate

32b. Lower holder plate

34a. Upper circular cushion

34a. Lower circular cushion

36a. Upper substitutable cleaning pad

36b. Lower substitutable cleaning pad

38. Refillable spray mini bottle for eye-glasses cleaner solution

40. Retractable cleaning brush

42. Left cover

44. Right cover

46. Left base

48. Right base

50. Back compartment slide lid

1.-2. (canceled)

3. An electromechanical portable eye-glasses cleaning device comprising:
a left assembled cover and a right assembled cover;
an upper holder plate and a lower holder plate; and
an upper microfiber cleaning pad and a lower microfiber cleaning pad, wherein the upper microfiber cleaning pad is attached to the upper holder plate, and the lower microfiber cleaning pad is attached to the lower holder plate;
wherein pressure on the left assembled cover and the right assembled cover will cause the upper holder plate and the lower holder plate to move towards one another a vertical axis, making both the upper microfiber cleaning pad and the lower microfiber cleaning pad simultaneously come into contact with both sides of a glasses lens, thereby providing a uniform, soft and effective cleaning by the rotation friction of microfiber pads without leaving lines or spots in their path and without causing damage to the glasses lens.

4. The device of claim 3, wherein the device hand-held and lightweight.

5. The device of claim 3, wherein the device includes a light source.

6. The device of claim 3, wherein the device includes a compartment housing a screwdriver and a retractable cleaning brush, and a refillable spray mini bottle for eye-glasses cleaner solution.

7. The device of claim 3, wherein the device includes a plunger assembly, the plunger assembly allowing for a user to exert pressure on the left assembled cover and the right assembled cover to move the upper holder plate and the lower holder plate to move towards one another the vertical axis.

8. The device of claim 7, further comprising a piston within the plunger assembly, the piston configured to be actuated to allow the upper holder plate and the lower holder plate to move towards one another.

9. The device of claim 8, further comprising a micro-spring inside the plunger.

10. The device of claim 3, further comprising a limit switch, the limit switch configured to control the timing of the rotation of both the upper microfiber cleaning pad and the lower microfiber cleaning pad.

11. The device of claim 3, further comprising an upper circular cushion and a lower circular cushion, the upper circular cushion and the lower circular cushion each connected to the upper microfiber cleaning pad and the lower microfiber cleaning pad, respectively, and connecting the upper microfiber cleaning pad and the lower microfiber cleaning pad to the upper holder plate and the lower holder plate, thereby providing an additional protective layer between the upper holder plate and the lower holder plate with the glass lens, minimizing damage possibilities of the glass lens.

12. The device of claim 3, wherein the upper circular cushion and the lower circular cushion are glued on the upper holder plate and the lower holder plate.

13. A method of cleaning portable eye-glasses comprising:
providing a device according to claim 3;
placing a glasses lens between the upper and lower microfiber cleaning pads;
pressing down on the left and the right assembled covers, thereby allowing them to move vertically down along a vertical axis;
providing an electronic or mechanical feeding of rotational motion to holder plates by means of impulse mechanism or by the micromotors feed by a battery and the wires, thereby giving the holder plates required rotational motion,
simultaneously contacting both sides of the lens with the upper and the lower microfiber cleaning pads, thereby providing a uniform, soft and effective cleaning by the rotation friction of microfiber pads; without leaving lines or spots in their path and without causing damage to the lens.

14. The method of claim 13, further comprising wiping the glasses lens with a retractile cleaning brush prior to the step of placing the glasses lens between the upper and the lower substitutable cleaning pads.

15. The method of claim 13, further comprising adding cleaning solution to both sides of the glasses lens prior to the step of placing the glasses lens between the upper and the lower substitutable cleaning pads.
